(19) United States
(12) Patent Application Publication
(10) Pub. No.: US 2026/0356340 A1
(43) Pub. Date: Nov. 12, 2026

(54) ABS CONTROL VALVE AND METHOD FOR TESTING THE ABS CONTROL VALVE

(71) Applicant: ZF CV Systems Europe BV, Brussels (BE)

(72) Inventor: Joachim Pracht, Hannover (DE)

(21) Appl. No.: 19/103,012

(22) PCT Filed: Jul. 25, 2023
(86) PCT No.: PCT/EP2023/070533

§ 371 Date: Feb. 11, 2025

(30) Foreign Application Priority Data
Aug. 12, 2022 (DE) 10 2022 120 427.8

(51) Int. Cl. B60T 17/22; B60Q 5/00; B60Q 9/00; B60T 15/02; F16K 37/00

(52) U.S. Cl. CPC B60T 17/22; B60T 15/027; F16K 37/0041; B60Q 5/005; B60Q 9/00; B60T 2250/00; B60T 2270/10; B60T 2270/406

(57) ABSTRACT

An ABS control valve (4) and method for testing its function is provided. The method tests the pneumatic switching functionality of the ABS control valve. In the method, a brake pressure p_{B_E} is input into the wheel brake line (30) by an axle modulator valve, the brake pressure profile p_{B_E}(t) in an inlet-side section (30a) of the wheel brake line is measured and stored in a brake control unit (8), at least one switchover of the inlet valve or of the outlet valve is initiated by activation or deactivation of the pilot control valves of the ABS control valve during the measurement of the brake pressure profile, and, finally, it is determined on the basis of the brake pressure profile whether an inlet control channel (70, 70a, 70b) or an outlet control channel (68, 68a), which connect the two pilot control valves to one another, is open or closed.

### FIELD

The present disclosure relates to an ABS control valve and to a method for testing the function of this ABS control valve, which ABS control valve has a brake pressure inlet, a brake pressure outlet, a ventilation outlet, a pressure-controlled inlet valve and a pressure-controlled outlet valve, wherein the inlet valve and the outlet valve are each assigned a 3/2 directional solenoid valve as a pilot control valve, by way of the energization of which the inlet valve can be closed and the outlet valve can be opened, wherein the ABS control valve is arranged in a wheel brake line of an electropneumatic brake system of a vehicle, between an axle modulator valve and at least one wheel brake cylinder, in which method the pneumatic switching functionality of the ABS control valve can be tested by way of a test function.

### BACKGROUND

The use of the method according to the present disclosure accordingly assumes the presence of an electropneumatic brake system of a vehicle such as is known per se, in which the wheel brakes of the vehicle axles are assigned to different brake circuits. Here, the brake pressures for the wheel brake cylinders of the front axle and of the at least one rear axle are input by way of in each case one axle modulator valve into the wheel brake lines, which lead to the wheel brake cylinders, in accordance with a braking value detected by sensor devices or calculated in a control program on the basis of operating parameters of the vehicle. The input brake pressure is detected in each case by way of a pressure sensor, which may be arranged inside or on the outside of the associated axle modulator valve. In the wheel brake lines, between the axle modulator valves and the wheel brake cylinders or directly at the axle modulator valves, there is arranged in each case one ABS control valve by way of which the brake pressure of each wheel brake cylinder can be reduced as required, in particular in the event of locking or a locking tendency of the associated wheel.

Such an electropneumatic brake system is known for example from DE 10 2017 007 788 A1. In this brake system, the ABS control valves of the front axle are each arranged in the wheel brake lines between the axle modulator valve and the associated wheel brake cylinder, whereas the ABS control valves of the rear axle are each arranged directly on, or integrated into, the axle modulator valve. In DE 2017 007 788 A1, the construction and functioning of the axle modulator valve of the front axle are also discussed on the basis of FIG. 3 of said document.

The ABS control valves commonly have an inlet valve and an outlet valve in order to be able to implement the “increase brake pressure”, “maintain brake pressure” and “reduce brake pressure” switching functions. Whilst ABS control valves in brake systems of passenger cars and light utility vehicles are commonly designed as directly control solenoid valves, it is preferable in brake systems of heavy utility vehicles such as trucks and buses, owing to the wheel brake cylinders of large volume that are installed therein, to use pilot-controlled inlet valves and pilot-controlled outlet valves designed as pressure-controlled diaphragm valves or piston valves, which can be actuated in each case by a solenoid valve.

A typical ABS control valve having pilot-controlled inlet valves and outlet valves designed as diaphragm valves is disclosed for example in DE 10 2019 131 128 A1, in which the construction and functioning of the ABS control valve are discussed on the basis of FIG. 2 of said document.

Whilst the axle modulator valves are commonly fastened centrally to the vehicle frame close to the respectively associated vehicle axle, the ABS control valves, if not integrated into or flange-mounted onto the associated axle modulator valve, are arranged close to the wheel brake cylinder, in or on the associated wheel well. It is possible in this way to achieve short flow paths of the inflowing and outflowing compressed air, and thus a fast response behavior of the wheel brakes, for ABS control. Because the ABS control valves in this arrangement are however highly exposed to external influences such as stirred-up dirt and water spray, there is the risk, in particular if a diaphragm seal at the ventilation outlet is damaged or brittle, that is to say is no longer resiliently elastic, that dirt particles and moisture ingress from the outside into the housing of an ABS control valve and result in control channels being blocked, in particular owing to the occurrence of corrosion. It is however also possible for dirt particles and moisture to be introduced into an ABS control valve with the compressed air that is fed via the associated axle modulator valve from a compressed-air treatment system. To ensure driving safety of the vehicle in question, there is therefore a demand to test the pneumatic switching functionality of the ABS control valves in their installed state.

DE 10 2008 022 953 A1 has disclosed a method for monitoring a solenoid valve of an electrical parking brake, in which method the electrical current profile or voltage profile at the magnet coil of the solenoid valve during the switchover thereof is measured and subsequently assessed. In the case of a functional solenoid valve, the rising current or voltage profile during the switchover of the solenoid valve exhibits a drop which is caused by the self-induction during the movement of the valve piston but which does not occur if the valve piston does not move. This known method however only allows the electromagnetic switching functionality of the solenoid valve to be tested.

By contrast, DE 10 2016 101 700 A1 describes a method for monitoring a solenoid valve, in which method a test signal is applied to one side of the magnet coil and a measurement signal is picked off at the other side of the magnet coil, and in which method the state of the solenoid valve is assessed on the basis of a comparison of the measurement signal with the test signal. In a preferred embodiment of the method in said document, the test signal consists of a particular number of voltage pulses. The state of the solenoid valve is assessed on the basis of a comparison of the number of voltage pulses in the measurement signal and in the test signal. This known method however only allows the electrical functionality of the solenoid valve to be tested.

### SUMMARY

It is the object of the present disclosure to specify a method for testing the function of an ABS control valve of the type and arrangement mentioned at the outset, such that the pneumatic switching functionality of the ABS control valve can be tested. The present disclosure also relates to an ABS control valve by way of which this method can be carried out.

The object relating to a method is achieved by way of a method according to the present disclosure. The present disclosure further provides advantageous refinements. The present disclosure further provides a device having the features of an ABS control valve by way of which this method can be carried out.

Accordingly, the present disclosure firstly relates to a method for testing the function of an ABS control valve,
which ABS control valve has a brake pressure inlet, a brake pressure outlet, a ventilation outlet, a pressure-controlled inlet valve and a pressure-controlled outlet valve,
wherein the inlet valve and the outlet valve are each assigned a 3/2 directional solenoid valve as a pilot control valve,
by way of the energization of which the inlet valve can be closed and the outlet valve can be opened,
wherein the ABS control valve is arranged in a wheel brake line of an electropneumatic brake system of a vehicle, between an axle modulator valve and at least one wheel brake cylinder,
in which method the pneumatic switching functionality of the ABS control valve is tested by way of a test function.

In this method, to achieve the stated object,
a brake pressure p_{B_E} is input into the wheel brake line by way of the axle modulator valve,
the brake pressure profile p_{B_E}(t) with respect to time in an inlet-side section of the wheel brake line is subsequently measured by way of a pressure sensor, and the measured values of this brake pressure profile are stored in an electronic brake control unit,
at least one switchover of the inlet valve or of the outlet valve is initiated by activation or deactivation of at least one of the pilot control valves of the ABS control valve during the measurement of the brake pressure profile p_{B_E}(t),
and, finally, it is assessed on the basis of the brake pressure profile p_{B_E}(t) whether an inlet control channel or an outlet control channel, which connect the two pilot control valves to one another, is open or closed.

The activation, that is to say electrical energization, or deactivation of at least one of the two pilot control valves of the ABS control valve during the measurement of the brake pressure profile initiates a switchover of the inlet valve or of the outlet valve, which switchover however actually occurs only in the case of an open inlet control channel or open outlet control channel. Likewise, the inlet valve or the outlet valve is held closed, which also occurs only in the case of an open inlet control channel or open outlet control channel. Therefore, on the basis of the brake pressure profile, it can be assessed whether the inlet control channel or the outlet control channel, which pneumatically connect the two pilot control valves to one another, is open or closed.

In one embodiment of the method, following the inputting of the brake pressure p_{B_E} into the wheel brake line, in a first part of the test function, the inlet valve is closed by activation of the associated first pilot control valve, and the inlet control channel is assessed as being open if the brake pressure p_{B_E} has remained constant, and is assessed as being closed if the brake pressure p_{B_E} has fallen.

If the inlet control channel is closed, the input brake pressure does not pass, or passes only with intense retardation and throttling, into the control chambers of the inlet valve and of the outlet valve, such that the inlet valve remains open and the outlet valve is opened, leading to a fall in the brake pressure in the wheel brake line.

In a continuation of the method, which is implemented only if an open inlet control channel has been identified in the first part of the test function, in an immediately subsequent second part of the test function, if an open inlet control channel has been identified in the first part of the test function, a second part of the test function is immediately subsequently executed, in which an opening pulse of the outlet valve is caused by brief activation of the associated second pilot control valve, and an opening pulse of the inlet valve is thereupon caused by brief deactivation of the associated first pilot control valve, and the outlet control channel is assessed as being open if the brake pressure p_{B_E} has fallen, and is assessed as being closed if the brake pressure p_{B_E} has been kept constant.

If the outlet control channel is closed, then during the opening pulse, the ambient pressure does not pass, or passes only with intense retardation, into the control chambers of the inlet valve and of the outlet valve, such that both valves remain closed, leading to the brake pressure in the inlet-side section of the wheel brake line being maintained.

It is commonly the case that two wheel brake lines each having an ABS control valve, that is to say one wheel brake line having one ABS control valve per side of the vehicle, are connected to each axle modulator valve. Therefore, in another advantageous refinement of the method, in the case of a plurality of ABS control valves connected via in each case one wheel brake line to the axle modulator valve, the test function is executed separately for each of the ABS control valves in a defined sequence in order to achieve unique assignment of the results of the test function.

To ensure driving safety of the vehicle, it may also advantageously be the case that, before the test function is executed, the present operating state of the vehicle is ascertained, and the test function is executed only if the vehicle is in an operating state that does not pose a risk to driving safety.

This may for example be implemented in that, before the test function is executed, the present driving speed v_{F} and the present operating state of the parking brake are ascertained by a sensor device, and the test function is executed only if the vehicle is at a standstill (v_{F}=0) and the parking brake is actuated.

Also, no actuation of the brake pedal or braking demand from a control program should occur during the execution of the test function, because this prevents or at least impedes the identification of closed control channels of the ABS control valves. Therefore, before the test function is executed, the present operating state of the service brake system is ascertained by a sensor device, and the test function is executed only if the service brake system is not actuated.

In another refinement of the method, the test function is preferably executed upon every commencement of operation of the vehicle.

It may however additionally be the case that the test function is executed upon every interruption of driving that occurs after the vehicle has covered a predefined driving distance or has driven for a predefined length of time since the last execution of the test function.

In order to provide information to the driver, following the execution of the test function, an acoustic and/or visual signal indicating the end of the test function is advantageously output in the region of the driver's position. Furthermore, the result of the test function may for this purpose be displayed on a display of an infotainment system.

Furthermore, an acoustic and/or visual warning signal should be output in the region of the driver's position if a closed inlet control channel of the ABS control valve has been identified in the first part of the test function or a closed outlet control channel of the ABS control valve has been identified in the second part of the test function.

It may also advantageously be the case that a fault message is stored in the fault memory of a brake control unit, and a prompt to visit a workshop is displayed on the display of the infotainment system, if a closed inlet control channel of the ABS control valve has been identified in the first part of the test function or a closed outlet control channel of the ABS control valve has been identified in the second part of the test function.

To achieve the object relating to a device, an ABS control valve is proposed which has a brake pressure inlet, a brake pressure outlet, a ventilation outlet, a pressure-controlled inlet valve and a pressure-controlled outlet valve, wherein the inlet valve and the outlet valve are each assigned a 3/2 directional solenoid valve as a pilot control valve, by way of the energization of which the inlet valve can be closed and the outlet valve can be opened. According to the present disclosure, in this ABS control valve, the two pilot control valves are pneumatically connected to one another via an inlet control channel and an outlet control channel. As mentioned, by using the method discussed above, it is possible to test whether or not this ABS control valve is fully functional.

### BRIEF DESCRIPTION OF THE DRAWINGS

The present disclosure will be discussed in more detail below on the basis of an exemplary embodiment illustrated in the appended drawings. In the drawings:

FIG. 1 shows, in a schematic illustration, a section of an electropneumatic brake system having an axle modulator valve, an ABS control valve, a wheel brake cylinder and an electronic brake control unit, and

FIG. 2 shows the ABS control valve of FIG. 1 in an enlarged illustration.

### DETAILED DESCRIPTION

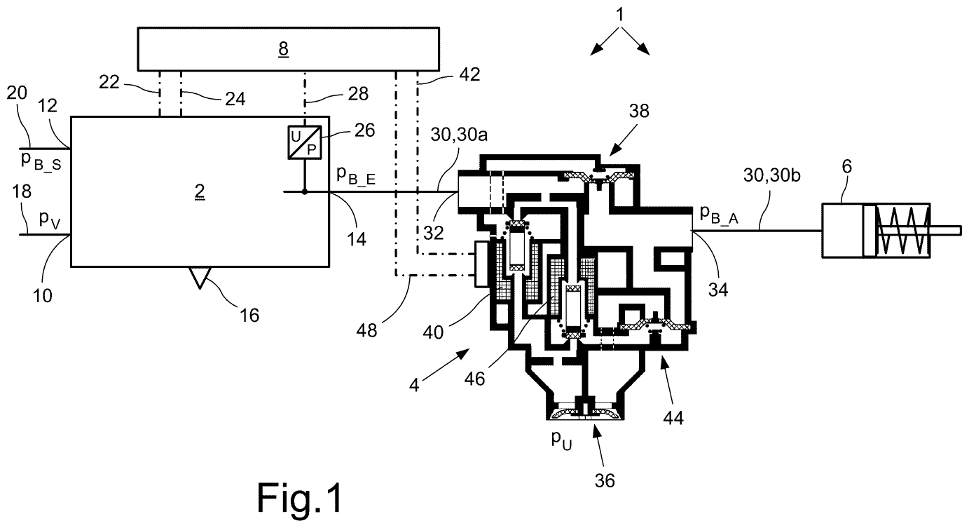

An electropneumatic brake system 1 of a vehicle as shown in FIG. 1 includes an axle modulator valve 2 assigned to a vehicle axle, an ABS control valve 4 assigned to a vehicle wheel of said vehicle axle, a wheel brake cylinder 6, and an electronic brake control unit 8.

The axle modulator valve 2, which is illustrated in simplified form, has a reservoir inlet 10, a brake control inlet 12, a brake pressure outlet 14 and a ventilation outlet 16. A reservoir line 18 in which a pneumatic reservoir pressure p_{V} prevails is connected to the reservoir pressure inlet 10. A brake control line 20, in which a brake control pressure p_{B_S} prevails when the service brake system 1 of the vehicle is actuated, is connected to the brake control inlet 12.

The axle modulator valve 2 includes at least two solenoid valves which are each connected via an electrical control line 22, 24 to the brake control unit 8. The solenoid valves may be directly controlled inlet valves and outlet valves, or may be pilot control valves of the inlet valves and outlet valves. By way of the axle modulator valve 2, a brake pressure p_{B_E} is modulated in accordance with an electronic braking value during normal operation and in accordance with the brake control pressure p_{B_S} in a redundancy situation, that is to say in the event of failure of the electronic control, and said brake pressure prevails at the brake pressure outlet 14. Said brake pressure p_{B_E} is detected by way of a pressure sensor 26, which in the present case is arranged, by way of example, within the axle modulator valve 2 and which is connected via an electrical sensor line 28 to the brake control unit 8.

Connected to the brake pressure outlet 14 of the axle modulator valve 2 is a wheel brake line 30, which leads to the wheel brake cylinder 6 of the associated vehicle axle. The ABS control valve 4 is arranged in the wheel brake line 30, between the axle modulator valve 2 and the wheel brake cylinder 6. The ABS control valve 4 has a brake pressure inlet 32, a brake pressure outlet 34 and a ventilation outlet 36. The brake pressure p_{B_E}, which in relation to the ABS control valve 4 is referred to here as inlet brake pressure, prevails at the brake pressure inlet 32, which is connected via an inlet-side section 30a of the wheel brake line 30 to the brake pressure outlet 14 of the axle modulator valve 2. An outlet brake pressure p_{B_A}, which may deviate from the inlet brake pressure p_{B_E} depending on the operating state of the ABS control valve 4, prevails at the brake pressure outlet 34, which is connected via an outlet-side section 30b of the wheel brake line 30 to the wheel brake cylinder 6. The ABS control valve 4 has a pressure-controlled inlet valve 38 and a pressure-controlled outlet valve 44, which are respectively assigned a first pilot control valve 40 and a second pilot control valve 46. These two pilot control valves 40, 46 are designed as 3/2 directional solenoid valves, which are connected via in each case one electrical control line 42, 48 to the brake control unit 8.

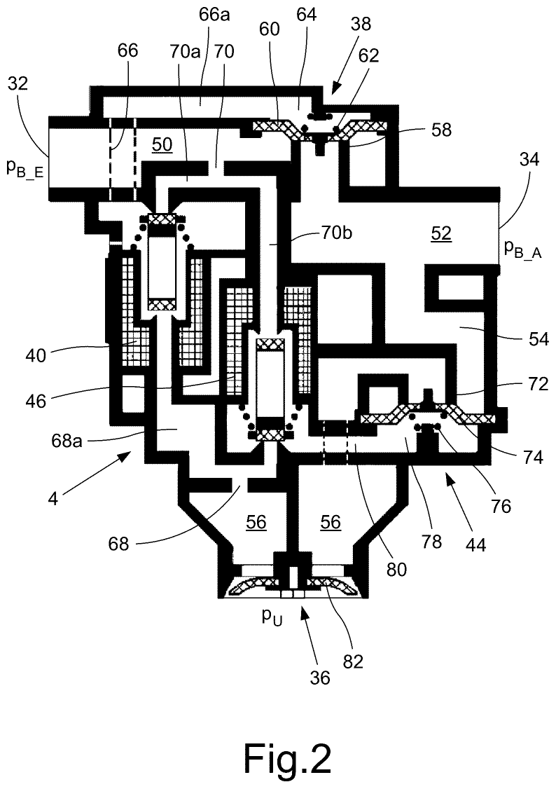

The construction and functioning of the ABS control valve 4 will be discussed in more detail below on the basis of the enlarged illustration of the ABS control valve 4 in FIG. 2.

The ABS control valve 4 has an inlet channel 50 leading from the brake pressure inlet 32 to the inlet valve 38, an outlet channel 52 leading from the inlet valve 38 to the brake pressure outlet 34, a side channel 54 branching off from the outlet channel 52 and leading to the outlet valve 44, and an outlet chamber 56 leading from the outlet valve 44 to the ventilation outlet 36. By way of the inlet valve 38, the outlet channel 52 can be selectively connected to or shut off with respect to the inlet channel 50 depending on the switching position of the inlet valve 38. By way of the outlet valve 44, the side channel 54 can be selectively connected to or shut off with respect to the outlet chamber 56 depending on the switching position of the outlet valve 44.

The inlet valve 38 is designed as a diaphragm valve and comprises a valve seat 58, a diaphragm 60, a valve spring 62 and a first control chamber 64. When the brake pressure inlet 32 is unpressurized, the diaphragm 60 is forced by the valve spring 62 against the valve seat 58, whereby the inlet valve 38 is closed, as shown in FIG. 2. By way of the associated first pilot control valve 40, the ambient pressure p_{U} prevailing at the ventilation outlet 36 or the inlet brake pressure p_{B_E} prevailing at the brake control inlet 32 can be applied, selectively, to the first control chamber 64 of the inlet valve 38. For this purpose, when the first pilot control valve 40 is inactive, that is to say electrically deenergized, a control channel 66, 66a leading to the control chamber 64 of the inlet valve 38 is connected via an outlet control channel 68, 68a to the outlet chamber 56. If pressure is prevailing at the brake pressure inlet 32, this results in the inlet valve 38 being opened. By contrast, if the first pilot control valve 40 is active, that is to say electrically energized, the control channel 66, 66a is connected via an inlet control channel 70, 70a to the inlet channel 50, which results in the inlet valve 38 being closed by way of the valve spring 62.

The outlet valve 44 is also designed as a diaphragm valve and comprises a valve seat 72, a diaphragm 74, a valve spring 76 and a second control chamber 78. When the brake pressure inlet 32 is unpressurized and the brake pressure outlet 34 is unpressurized, the diaphragm 74 is forced by the valve spring 76 against the valve seat 72, whereby the outlet valve 44 is closed, as shown in FIG. 2. By way of the associated second pilot control valve 46, the inlet brake pressure p_{B_E} prevailing at the brake control inlet 32 or the ambient pressure p_{U} prevailing at the ventilation outlet 36 can be applied, selectively, to the control chamber 78 of the outlet valve 44. For this purpose, when the second pilot control valve 46 is inactive, that is to say electrically deenergized, a control channel 80 leading to the control chamber 78 of the outlet valve 44 is connected via the inlet control channel 70, 70b to the inlet channel 50, which results in the outlet valve 44 being closed if pressure is prevailing at the brake pressure inlet 32. By contrast, if the second pilot control valve 46 is active, that is to say electrically energized, the control channel 80 is connected via the outlet control channel 68 to the outlet chamber 56, which results in the outlet valve 44 being opened.

If the pilot control valves 40, 46 are electrically deenergized, it is thus the case that the inlet valve 38 is open and the outlet valve 44 is closed, which corresponds to the “increase brake pressure” switching function of the ABS control valve 4. If the first pilot control valve 40 is electrically energized and the second pilot control valve 46 is electrically deenergized, it is then the case that the inlet valve 38 and the outlet valve 44 are closed, which corresponds to the “maintain brake pressure” switching function of the ABS control valve 4. If the pilot control valves 40, 46 are electrically energized, it is then the case that the inlet valve 38 is closed and the outlet valve 44 is open, which corresponds to the “reduce brake pressure” switching function of the ABS control valve 4.

In such an ABS control valve 4, dirt particles and moisture can be introduced into the inlet channel 50 with the compressed air that flows in via the brake pressure inlet 32, and this can result in the inlet control channel 70, 70a, 70b being blocked owing to the occurrence of corrosion. In particular if arranged in or on a wheel well of a vehicle axle, an ABS control valve 4 is highly exposed to external influences such as stirred-up dirt and water spray. There is therefore the risk, in particular if a diaphragm seal 82 at the ventilation outlet 36 is damaged or brittle, that is to say is no longer resiliently elastic, that dirt particles and moisture ingress from the outside into the outlet chamber 80, which can result in the outlet control channel 68, 68a being blocked, in particular owing to the occurrence of corrosion. If the inlet control channels 68, 68a and/or outlet control channels 70, 70a, 70b are blocked, the switching functionality of the inlet valve 38 and/or of the outlet valve 44 is no longer available, or is at least severely limited.

Therefore, in the method according to the present disclosure for testing the function of an ABS control valve 4, provision is made for the pneumatic switching functionality of the ABS control valve 4 to be tested by carrying out a test function. In general, for this purpose, a brake pressure p_{B_E} is input into the wheel brake line 30, 30a by way of the axle modulator valve 2; the brake pressure profile p_{B_E}(t) with respect to time in the inlet-side section 30a of the wheel brake line 30 is subsequently measured by way of the pressure sensor 26 arranged in the axle modulator valve 2 and electronically stored; at least one switchover of the inlet valve 38 or of the outlet valve 44 is initiated by activation or deactivation of at least one of the two pilot control valves 40, 46 of the ABS control valve 4 during the detection of the brake pressure profile p_{B_E}(t); and finally, it is assessed on the basis of the brake pressure profile p_{B_E}(t) with respect to time whether the inlet control channel 70, 70a, 70b or the outlet control channel 68, 68a of the two pilot control valves 40, 46 is open or closed.

Specifically, in one preferred embodiment of the method, following the inputting of the brake pressure p_{B_E} into the wheel brake line 30, 30a, in a first part of the test function, the inlet valve 38 is closed by activation of the associated first pilot control valve 40, and the inlet control channel 70, 70a, 70b is assessed as being open if the brake pressure p_{B_E} has subsequently been kept at least substantially constant, and the inlet control channel 70, 70a, 70b is assessed as being closed if the brake pressure p_{B_E} has fallen. If the inlet control channel 70, 70a, 70b is closed, the input brake pressure p_{B_E} specifically does not pass, or passes only with intense retardation and throttling, into the two control chambers 64, 78 of the inlet valve 38 and of the outlet valve 44, such that the inlet valve 38 remains open and the outlet valve 44 is opened, leading to a fall in the brake pressure p_{B_E} in the wheel brake line 30, 30a, 30b.

If an open inlet control channel 70, 70a, 70b has been identified in the first part of the test function, a second part of the test function is immediately subsequently executed. In said second part of the test function, an opening pulse of the outlet valve 44 is effected by brief activation of the associated second pilot control valve 46, and an opening pulse of the inlet valve 38 is thereupon effected by brief deactivation of the associated first pilot control valve 40, and the outlet control channel 68, 68a is assessed as being open if the brake pressure p_{B_E} has fallen, and is assessed as being closed if the brake pressure p_{B_E} has been kept constant.

If the outlet control channel 68, 68a is closed, then during the opening pulse, the ambient pressure p_{U} does not pass, or passes only with intense retardation, into the control chamber 64 of the inlet valve 38 and into the control chamber 78 of the outlet valve 44, such that both valves 38, 44 remain closed, leading to the brake pressure p_{B_E} in the inlet-side section 30a of the wheel brake line 30 being kept constant.

### LIST OF REFERENCE SIGNS (PART OF THE DESCRIPTION)

1 Electropneumatic brake system
2 Axle modulator valve
4 ABS control valve
6 Wheel brake cylinder
8 Electronic brake control unit
10 Reservoir pressure inlet
12 Brake control inlet
14 Brake pressure outlet
16 Ventilation outlet
18 Reservoir line
20 Brake control line
22 Control line
24 Control line
26 Pressure sensor
28 Sensor line
30 Wheel brake line
30a Wheel brake line, inlet-side section
30b Wheel brake line, outlet-side section
32 Brake pressure inlet
34 Brake pressure outlet
36 Ventilation outlet
38 Inlet valve, diaphragm valve
40 First pilot control valve, 3/2 directional solenoid valve
42 Control line
44 Outlet valve, diaphragm valve
46 Second pilot control valve, 3/2 directional solenoid valve
48 Control line
50 Inlet channel
52 Outlet channel
54 Side channel
56 Outlet chamber
58 Valve seat of the inlet valve
60 Diaphragm of the inlet valve
62 Valve spring of the inlet valve
64 First control chamber
66, 66a Control channel
68, 68a Outlet control channel
70, 70a, 70b Inlet control channel
72 Valve seat of the outlet valve
74 Diaphragm of the outlet valve
76 Valve spring of the outlet valve
78 Second control chamber
80 Control channel
82 Diaphragm seal
ABS Anti-lock system
p_{B_A} Brake pressure, outlet brake pressure
p_{B_E} Brake pressure, inlet brake pressure
p_{B_S} Brake control pressure
p_{U} Ambient pressure
p_{V} Reservoir pressure
t Time
v_{F} Driving speed

1. A method for testing the function of an ABS control valve (4), the method comprising:
providing an ABS control valve having a brake pressure inlet (32), a brake pressure outlet (34), a ventilation outlet (36), a pressure-controlled inlet valve (38) and a pressure-controlled outlet valve (44),
wherein the inlet valve (38) and the outlet valve (44) are each assigned a 3/2 directional solenoid valve as a pilot control valve (40, 46),
wherein energizing the respective associated pilot control valve, respectively closes the inlet valve (38) and respectively opens the outlet valve (44),
wherein the ABS control valve (4) is arranged in a wheel brake line (30) of an electropneumatic brake system (1) of a vehicle, between an axle modulator valve (2) and at least one wheel brake cylinder (6),
testing a pneumatic switching functionality of the ABS control valve (4) by performing a test function,
wherein performing test function includes:
inputting a brake pressure (p_{B_E}) into the wheel brake line (30, 30a) by the axle modulator valve (2),
measuring a brake pressure profile (p_{B_E}(t)) with respect to time in an inlet-side section (30a) of the wheel brake line (30) is subsequently measured by a pressure sensor (26) and stored in an electronic brake control unit (8),
initiating at least one switchover of the inlet valve (38) or of the outlet valve (44) by activation or deactivation of at least one of the pilot control valves (40, 46) of the ABS control valve (4) during the measurement of the brake pressure profile (p_{B_E}(t)),
determining, by the electronic brake control unit (8) on the basis of the brake pressure profile (p_{B_E}(t)), that an inlet control channel (70, 70a, 70b) or an outlet control channel (68, 68a), which connect the two pilot control valves (40, 46) to one another, is open or closed.

2. The method as claimed in claim 1,
wherein following the inputting of the brake pressure (p_{B_E}) into the wheel brake line (30, 30a), in a first part of the test function, the inlet valve (38) is closed by activation of the associated first pilot control valve (40), and
wherein the inlet control channel (70, 70a, 70b) is determined as being open if the brake pressure (p_{B_E}) has remained constant according to the brake pressure profile, and
wherein the inlet control channel is determined as being closed if the brake pressure (p_{B_E}) has fallen according to the brake pressure profile.

3. The method as claimed in claim 2,
wherein, in response to determining that the inlet control channel (70, 70a, 70b) is open in the first part of the test function, the test function further includes,
subsequently executing a second part of the test function in which the second part includes:
causing an opening pulse of the outlet valve (44) by brief activation of the associated second pilot control valve (46), and
causing an opening pulse of the inlet valve (38) by brief deactivation of the associated first pilot control valve (40), and
wherein the outlet control channel (68, 68a) is determined as being open when the brake pressure (p_{B_E}) has fallen according to the brake pressure profile, and is determined as being closed when the brake pressure (p_{B_E}) has been kept constant according to the brake pressure profile.

4. The method as claimed in claim 1, wherein in the case of a plurality of ABS control valves (4) connected via in each case one wheel brake line (30) to the axle modulator valve (2), the test function is executed separately for each of the ABS control valves (4) in a defined sequence.

5. The method as claimed in claim 1, wherein before the test function is executed, the present operating state of the vehicle is determined by the electronic brake control unit, and the test function is executed only if the vehicle is in a predefined operating state.

6. The method as claimed in claim 5, wherein, before the test function is executed, the present driving speed (v_{F}) and the present operating state of the parking brake are determined by a sensor, and the test function is executed only if the vehicle is at a standstill (v_{F}=0) and the parking brake is actuated.

7. The method as claimed in claim 1, wherein before the test function is executed, the present operating state of the service brake system (1) is determined by a sensor, and the test function is executed only if the service brake system (1) is not actuated.

8. The method as claimed in claim 1, wherein the test function is executed upon every commencement of operation of the vehicle.

9. The method as claimed in claim 1, wherein the test function is executed upon every interruption of driving that occurs after the vehicle has covered a predefined driving distance or has driven for a predefined length of time since a prior execution of the test function.

10. The method as claimed in claim 3, following the execution of the test function, an acoustic and/or visual signal indicating the end of the test function is output in the region of the driver's position, and the result of the test function is displayed on a display of an infotainment system.

11. The method as claimed in claim 3, wherein an acoustic and/or visual warning signal is output in the region of the driver's position in response to determining that the inlet control channel (70, 70a, 70b) is closed in the first part of the test function or in response to determining that the outlet control channel (68, 68a) is closed in the second part of the test function.

12. The method as claimed in claim 10, wherein fault message is stored in the fault memory of the electronic brake control unit (8), and a prompt to visit a workshop is displayed on the display of the infotainment system, in response to determining that the inlet control channel is closed in the first part of the test function or the outlet control channel is closed in the second part of the test function.

13. An ABS control valve (4), comprising:
a brake pressure inlet (32),
a brake pressure outlet (34),
a ventilation outlet (36),
a pressure-controlled inlet valve (38) and
a pressure-controlled outlet valve (44),
wherein the inlet valve (38) and the outlet valve (44) are each assigned a 3/2 directional solenoid valve as a first and second pilot control valve (40, 46), respectively,
wherein energizing the first and second pilot control valve respectively closes the inlet valve (38) and respectively opens the outlet valve (44),
wherein the first and second pilot control valves (40, 46) are pneumatically connected to one another via an inlet control channel (70, 70a, 70b) and an outlet control channel (68, 68a).

14. The ABS control valve of claim 13, wherein when the brake pressure inlet is unpressurized, the inlet valve is closed, and
wherein when the first pilot control valve is inactive and deenergized, a control channel (66, 66a) leading to a control chamber (64) of the inlet valve (38) is connected via the outlet control channel (68, 68a) to an outlet chamber 56, such that the inlet valve opens in response to brake pressure at the brake pressure inlet.
wherein, when the first pilot control valve (40) is active and energized, the control channel (66, 66a) is connected via the inlet control channel (70, 70a) to an inlet channel 50, such that the inlet valve (38) closes via a valve spring (62).

15. The ABS control valve of claim 14, wherein when the brake pressure inlet is unpressurized and brake pressure outlet is unpressurized, the outlet valve is closed,
wherein when the second pilot control valve (46) is inactive and deenergized, a control channel (80) leading to a control chamber (78) of the outlet valve 44 is connected via the inlet control channel (70, 70b) to the inlet channel (50), such that the outlet valve (44) is closed when the brake pressure inlet (32) is pressurized, and
wherein when the second pilot control valve (46) is active and energized, the control channel (80) is connected via the outlet control channel (68) to the outlet chamber (56), such that the outlet valve 44 is opened.

16. The ABS control valve of claim 15, wherein when the first and second pilot control valves are deenergized, the inlet valve is open and the outlet valve is closed to define an increase brake pressure switching state,
wherein when the first pilot control valve is energized and the second pilot control valve is deenergized, the inlet valve and the outlet valve are closed to define a maintain brake pressure switching state,
wherein when both the first pilot control valve is energized and the second pilot control valve is energized, the inlet valve is closed and the outlet valve is open to define a reduce brake pressure switching state.
